(19) United States
(12) Patent Application Publication
(10) Pub. No.: US 2009/0240900 A1
(43) Pub. Date: Sep. 24, 2009

(54) MEMORY APPARATUS AND MEMORY CONTROL METHOD

(75) Inventors: Yasuhide Sosogi, Kawasaki (JP); Kenji Ijitsu, Kawasaki (JP); Seiji Murata, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/397,672

(22) Filed: Mar. 4, 2009

(30) Foreign Application Priority Data
Mar. 21, 2008 (JP) 2008-073267

(51) Int. Cl. G06F 12/00

(52) U.S. Cl. 711/155; 711/E12.001

(57) ABSTRACT

A memory includes a plurality of blocks that each include a plurality of memory cell arrays connected to divided bit lines, a first decoder that generates a block select signal for selecting any of the blocks based on an inputted address signal, read/write portions disposed for the respective blocks, each of the read/write portions executes read or write of the memory cell array belonging to the block of its own, and signal generation portions each generates an operation control signal for bringing the read/write portion that belongs to the selected block into an operating state when the block thereof has been selected by the block select signal. Each of the signal generation portions generates an operation control signal for bringing the read/write portion that belongs to the block thereof into a non-operating state when the block thereof is not selected by the block select signal.

### CROSS-REFERENCE TO RELATED APPLICATIONS

This application is based upon and claims the benefit of priority of the prior Japanese Patent Application No. 2008-73267, filed on Mar. 21, 2008, the entire contents of which are incorporated herein by reference.

### FIELD

Various embodiments of the present invention relate to a memory and a memory control method.

### BACKGROUND

In recent years, with the microfabrication of a semiconductor and the higher integration and larger capacity of a cache memory, the decrease of a memory cell current or the increase of a bit-line parasitic capacitance have occurred, thereby posing the problem of the degradation of a read performance or the lowering of a stability.

A static random access memory (SRAM), for example, has been employed as the cache memory.

FIG. 5 illustrates a layout diagram showing an example of the cache memory. The cache memory illustrated in FIG. 5 includes a clock generator 11, a pre-decoder 12, a final decoder 13, a read/write block 14, a memory cell array 15 and an I/O circuit 16. The memory cell array 15 is divided into two portions, which are arranged so as to interpose the final decoder 13 therebetween. Each of the read/write block 14 and the I/O circuit 16 is divided into two portions, which are arranged so as to interpose the clock generator 11 and the pre-decoder 12 therebetween.

The clock generator 11 generates clocks, and feeds the clocks to the various parts of the cache memory. The I/O circuit 16 executes input/output processes from/to the exterior of the cache memory. The pre-decoder 12 and the final decoder 13 decode external address signals, so as to select a bit line and a word line within the memory cell array 15. The read/write block 14 includes sense amplifiers, etc., and it reads/writes data from/into the memory cell array 15.

Regarding such a cache memory, the bit line in the memory cell array 15 is long, and bringing out a sufficient performance is becoming difficult because of the decrease of a memory cell current, or the increase of a bit-line parasitic capacitance.

FIG. 6 illustrates a layout diagram showing an example of a cache memory that employs a bit-line division system. The cache memory includes a clock generator 21, a pre-decoder 22, an I/O circuit 23, control blocks 70, 71, 72 and 73, and local blocks 60, 61, 62 and 63. Each of the control blocks 70, 71, 72 and 73 includes a control generator 31 and a final decoder 32. Each of the local blocks 60, 61, 62 and 63 includes a read/write block 33 and a memory cell array 34.

Each of the local blocks 60, 61, 62 and 63 is divided into two portions, which are arranged so as to interpose the corresponding control block therebetween. In each of the two divided portions of the local block, the memory cell array 34 is further divided into two portions, which are arranged so as to interpose the read/write block 33 therebetween.

According to the cache memory, in which bit-lines are divided in the way discussed above, a bit line within the memory cell array 34 is short, and decrease of a memory cell current or increase of a bit-line parasitic capacitance can be prevented.

FIG. 7 illustrates a logical block diagram of the cache memory that employs the bit-line division system. The same reference numerals as in FIG. 6 designate constituents identical or equivalent to those shown in FIG. 6, and they shall be omitted from description here. Usually, as the basic operations of the cache memory, the pre-decoder 12 and the final decoder 32 decode input addresses, and the read/write block 33 reads or writes data retained in the memory cell array 34.

Internal control signals, such as a sense-amplifier enable signal, a bit pre-charge signal or the reset signal of a column select output node, control the read/write block 33 interposed between the memory cell arrays 34. The internal control signals are generated as pulses by the control generator 31 in a control block 24.

Incidentally, semiconductor devices each of which decreases an active standby current have been known as prior-art techniques from the following documents:

[Patent Document 1] JP-A-2004-213895

[Patent Document 2] JP-A-2004-259431

However, power consumption of the cache memory of the bit-line division system is large that all the local blocks become active at all times.

### SUMMARY

Various embodiments of the present invention provide a memory apparatus employing a bit-line division system including a plurality blocks, each block including one or more memory cell arrays connected to divided bit lines, a first decoder that generates a block select signal for selecting at least one of the blocks based on an inputted address signal, a plurality of read/write portions corresponding to the respective blocks, each of the read/write portions executing read or write of the one or more memory cell arrays belonging to a respective block, and a plurality of signal generation portions corresponding to the respective blocks, each of the signal generation portions generating an operation control signal for bringing the read/write portion that belongs to a specific block into an operating state when the specific block has been selected by the block select signal, and an operation control signal for bringing the read/write portion that belongs to the specific block into a non-operating state when the specific block is not selected by the block select signal.

Various embodiments of the present invention provide A memory control method for controlling a memory apparatus that employs a bit-line division system and includes a plurality blocks, each block including one or more memory cell arrays connected to divided bit lines, a first decoder, a plurality of read/write portions corresponding to the respective blocks, and a plurality of signal generation portions corresponding to the respective blocks. The method includes generating a block select signal for selecting a block based on an inputted address signal and allowing the signal generation portion that belongs to a block that is not selected by the block select signal to generate an operation control signal for bringing into a non-operating state the read/write portion that belongs to the non-selected block.

### BRIEF DESCRIPTION OF THE DRAWINGS

FIG. 1 is a logic block diagram showing an example of the configuration of a cache memory according to an embodiment of the present invention;

FIG. 2 is a circuit diagram showing an example of the configuration of and around a control generator according to an embodiment;

FIG. 3 is a circuit diagram showing an example of the configuration of a circuit A according to an embodiment;

FIG. 4 is a timing chart concerning timing adjustments in a cache memory according to an embodiment;

FIG. 5 is a layout configuration diagram showing an example of a prior-art cache memory;

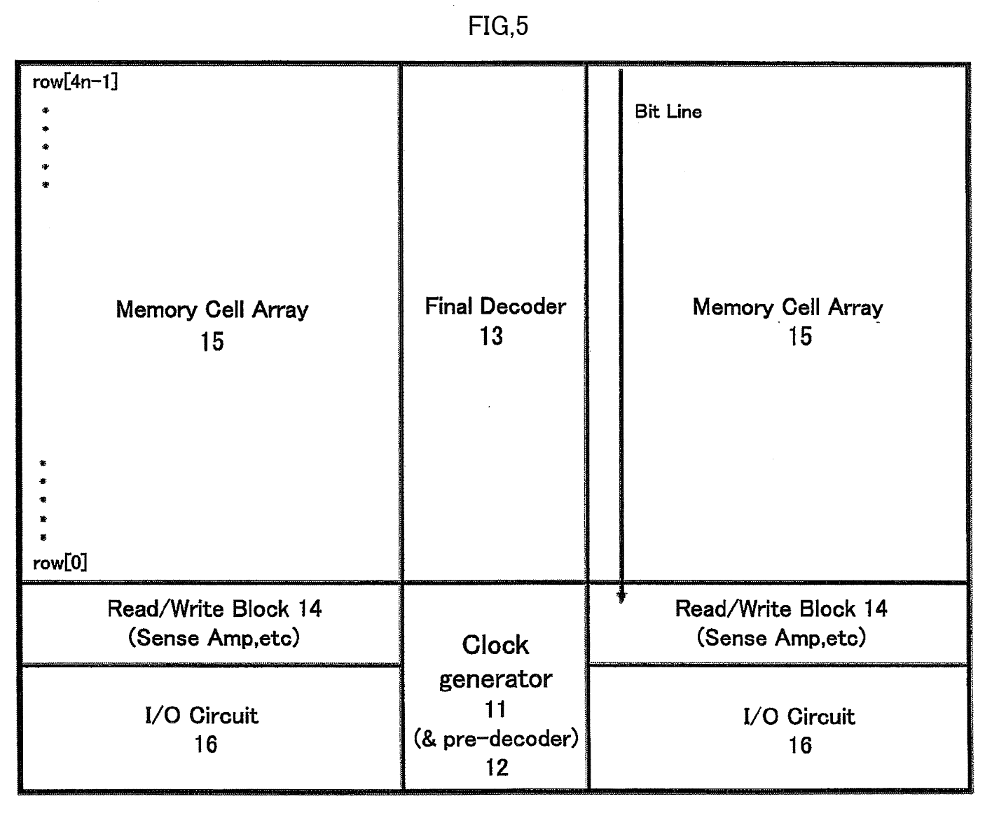

FIG. 6 is a layout configuration diagram showing an example of a prior-art cache memory that employs a bit-line division system; and

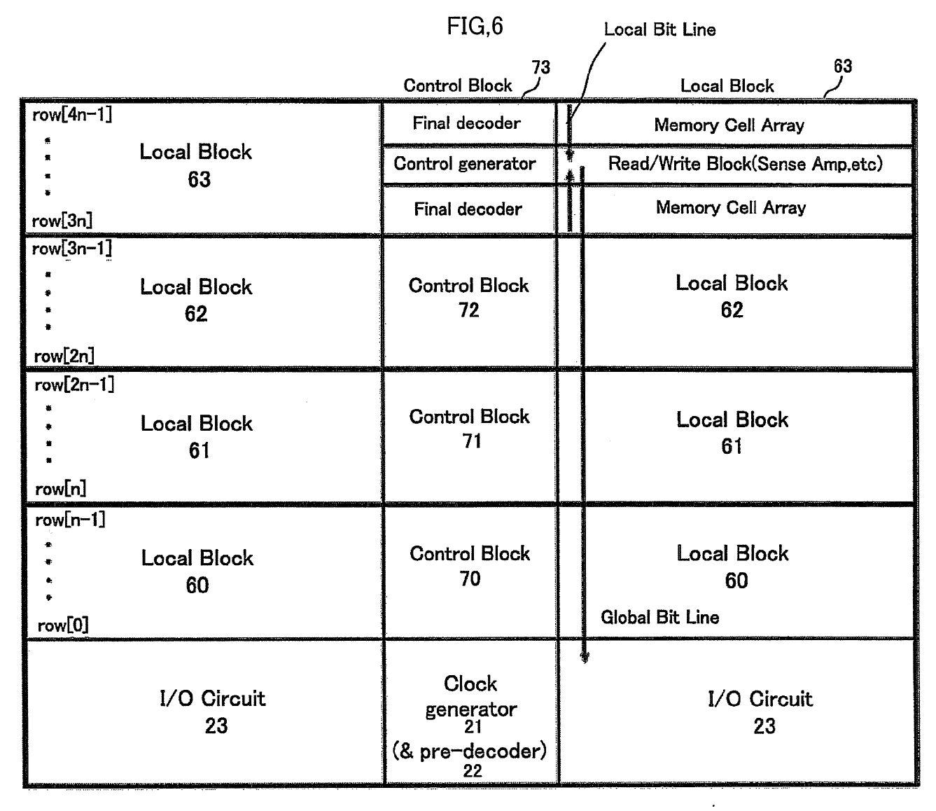

FIG. 7 is a logic block diagram of the prior-art cache memory that employs the bit-line division system.

### DESCRIPTION OF EMBODIMENT

An embodiment of the present invention will be described with reference to the drawings.

First, the configuration of a cache memory according to the embodiment will be described.

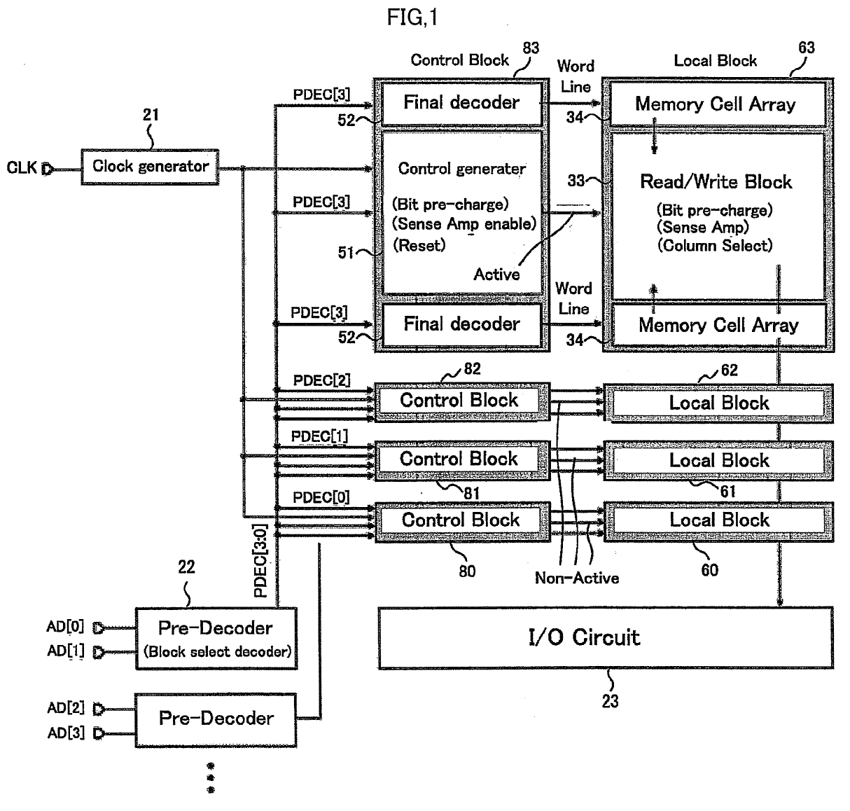

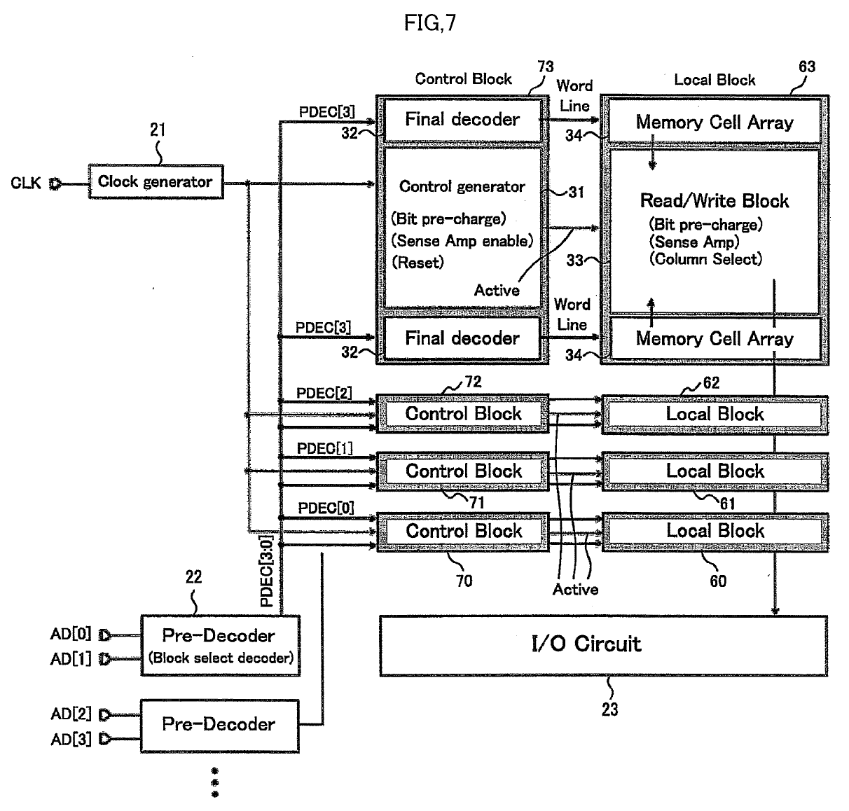

FIG. 1 is a logic block diagram illustrating an example of the configuration of a cache memory according to the embodiment. In FIG. 1, elements indicated by the same reference numerals as in FIG. 7 are identical or equivalent to elements shown in FIG. 7, and they shall be omitted from a detailed description here. The cache memory shown in FIG. 1 includes control blocks 80, 81, 82 and 83. Each of the control blocks 80, 81, 82 and 83 includes a control generator 51 and a final decoder 52. Here, the final decoder 52 is one aspect of a “second decoder”.

The cache memory according to the embodiment employs a bit-line division system, and the cache memory has local blocks 60, 61, 62 and 63 therein. The local block 60 corresponds to the control block 80. Likewise, the local block 61 corresponds to the control block 81, the local block 62 to the control block 82, and the local block 63 to the control block 83. The respective control blocks control the operations of the corresponding local blocks.

Internal control signals, operation control signals in other words, include signals such as sense amplifier enable signals for activating sense amplifiers, bit pre-charge signals for raising the voltages of both bit lines to a “Hi” (high) level before operation cycles in advance, and reset signals for resetting column select output nodes before the operation cycles in advance. The internal control signals are generated as pulses by the control generator 51, and they are fed to a read/write block 33 interposed between memory cell arrays 34, so as to operate the read/write block 33.

Each of pre-decoders 22 decodes an inputted address signal, thereby selecting the local block that is to be operated. In this embodiment, a pre-decode signal PDEC, which is the output signal of the pre-decoder 22 and which functions as a block select signal for selecting any of the local blocks 60, 61, 62 and 63, is inputted to the control generator 51 that is a logic for generating the internal control signals. PDEC[0], PDEC[1], PDEC[2] and PDEC[3] are the pre-decode signals for selecting the local blocks 60, 61, 62 and 63, respectively. The control generator 51 makes the internal control signal active, namely, an operating state, only for the selected local block, and then feeds the active signal.

FIG. 1 illustrates a case where the local block 63 has been selected by the pre-decode signal PDEC[3]. On this occasion, only the internal control signal from the control block 83 to the local block 63 becomes active, and the internal control signals from the control blocks 80, 81 and 82 to the corresponding local blocks 60, 61 and 62 become non-active, namely, non-operating states.

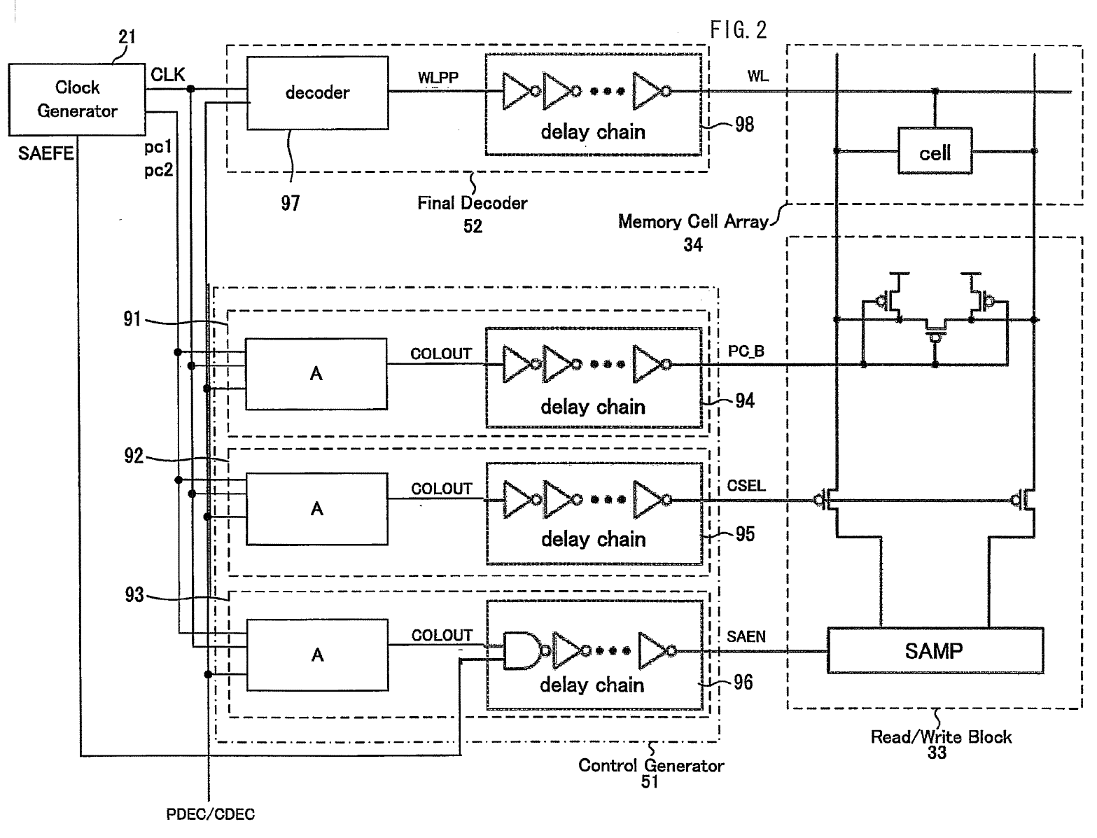

FIG. 2 is a circuit diagram illustrating an example of the configuration of elements around the control generator according to the embodiment. The control generator 51 includes a bit pre-charge signal generator 91, a column select output node reset signal generator 92, and a sense amplifier enable signal generator 93. The bit pre-charge signal generator 91 includes a circuit A, and a delay circuit 94 whose timing is adjusted. The column select output node reset signal generator 92 includes a circuit A, and a delay circuit 95 whose timing is adjusted. The sense amplifier enable signal generator 93 includes a circuit A, and a delay circuit 96 whose timing is adjusted.

Each of the circuits A generates a signal COLOUT from a clock (CLK) from a clock generator 21 and the pre-decode signal (PDEC)/a column decode signal (CDEC). The signal COLOUT is a signal on which the sense amplifier enable signal, the bit pre-charge signal and the column select output node reset signal are respectively based. Further, the delay circuit 94 affords a delay to the signal COLOUT, whereby the bit pre-charge signal PC_B is generated from the bit pre-charge signal generator 91. Likewise, the delay circuit 95 affords a delay to the signal COLOUT, whereby the column output node reset signal CSEL is generated from the column select output node reset signal generator 92. In the same manner, the delay circuit 96 affords a delay to the NAND operation result between the signal COLOUT and a signal SAEFE that is fed from the clock generator 21 and that indicates the operation timing of a sense amplifier (SAMP), whereby the sense amplifier enable signal SAEN for operating the sense amplifier is generated from the sense amplifier enable signal generator 93.

The final decoder 52 includes a decoder 97, and a delay circuit 98 whose timing is adjusted. The decoder 97 generates a signal WLPP for giving a command for the selection of a word line, from the signal PDEC/CDEC. Further, the delay circuit 98 affords a delay to the signal WLPP, whereby a signal WL for selecting the word line is generated from the final decoder 52.

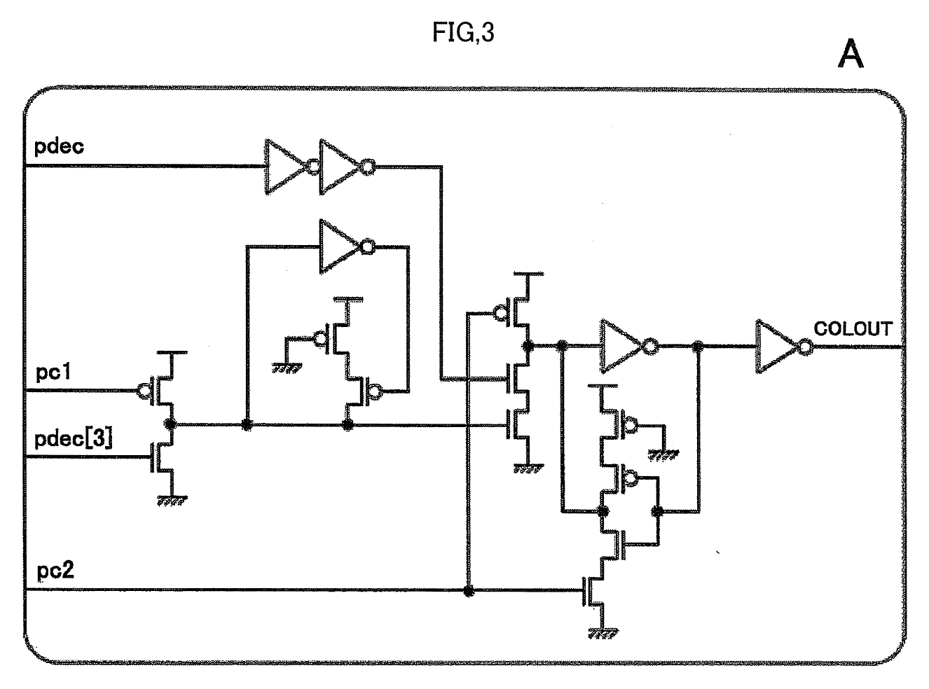

FIG. 3 is a circuit diagram illustrating an example of the configuration of the circuit A according to the embodiment. The clock generator 21 generates signals pc1 and pc2 indicating the timings of the pre-charge on the basis of the external clock CLK. The signals pc1, pc2 and PDEC are respectively inputted to the circuit A. By way of example, the circuit A in the control block 83 outputs the pulse as the signal COLOUT, only in a case where the corresponding local block 63 has been selected by the signal PDEC[3].

Next, the operation of the cache memory according to this embodiment will be described.

The pre-decoder 22 outputs the pre-decode signal PDEC[3:0] in response to the input of the address signal AD[0] or AD[1].

In this embodiment, the pre-decoder 22 shall be of NOR type. Regarding the pre-decode signal, a “low” level is outputted to the selected block, and a “high” level is outputted to the non-selected block. In this example, the selected block is the local block 63, and the non-selected blocks are the local blocks 60, 61 and 62.

For example in a case where the local block 63 has been selected by the pre-decode signal PDEC[3], the control generator 51 corresponding to the local block 63 makes the internal control signal for the corresponding read/write block 33 active, with the result that only the circuit of the local block 63 to-be-accessed is operated. On this occasion, the respective control generators corresponding to the non-selected local blocks 60, 61 and 62 make the internal control signals for the corresponding read/write blocks 33 non-active, and the local blocks 60, 61 and 62 do not operate. That is, only the required minimum local blocks are made active, whereby increase of the power consumption can be prevented.

Next, the circuit configurations and timing adjustments of the control generator 51 and the final decoder 52 is described.

In this embodiment, part of the circuit A within the control generator 51 and part of the decode circuit 97 within the final decoder 52 are identical in circuit configuration to each other.

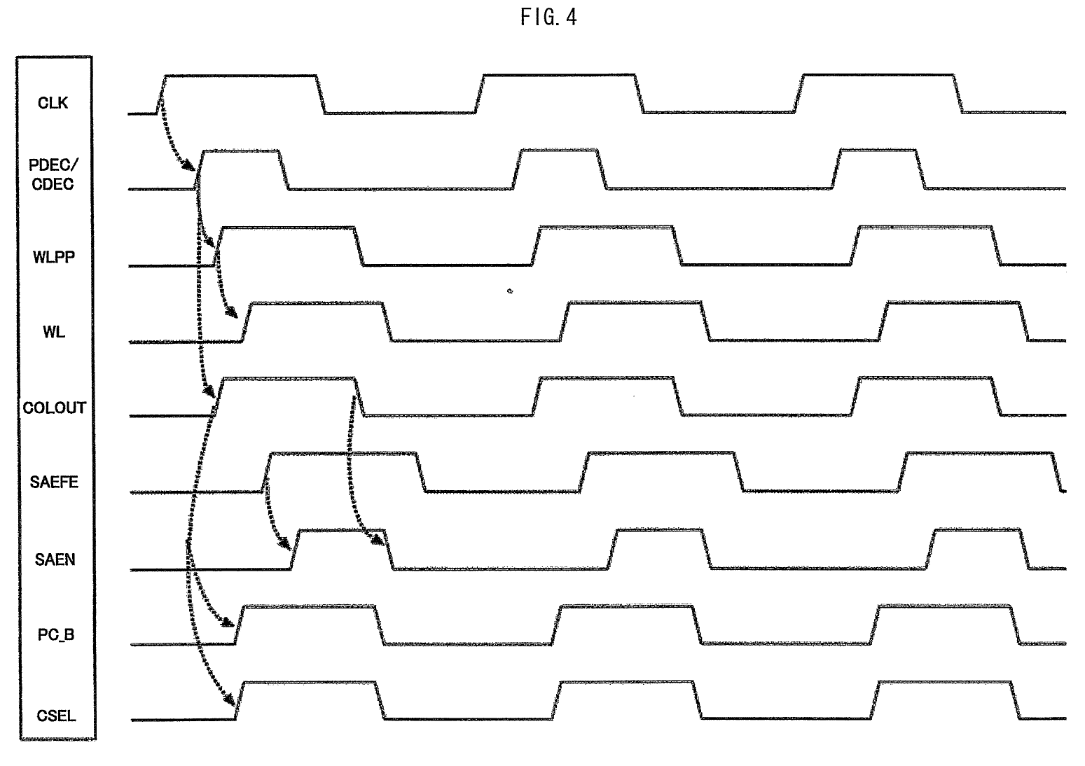

FIG. 4 is a timing chart concerning the timing adjustments in the cache memory according to this embodiment. First, the rise of the signal PDEC/CDEC is generated with reference to the rise of the signal CLK. Also, the rises of the signals WLPP and COLOUT are generated with reference to the rise of the signal PDEC/CDEC. In addition, the signal WL is generated by affording the delay to the signal WLPP. The signals PC_B and CSEL are generated by affording the delay to the signal COLOUT. The fall of the signal SAEN is generated by affording the delay to the fall of the signal COLOUT.

Since the circuit A and the decode circuit 97 include the identical circuits, the signal COLOUT, being the output of the circuit A, and the signal WLPP, being the output of the decode circuit 97, fluctuate similarly in accordance with an environmental change.

A case where the circuits of the final decoder 52 and the control generator 51 are different is compared to a case where they are identical. In the case where the circuits of the final decoder 52 and the control generator 51 are identical, as in this embodiment, the internal control signals favorably follow up the changes of the start/release timings of word lines attributed to process, voltage and temperature changes, so that the discrepancies of the timings among the signals can be made small. Besides, the layouts of identical shape are employed for the final decoder 52 and the control generator 51, whereby the reduction of a manufacturing dispersion can be expected. These lead to the prevention of the malfunction of the cache memory and the enhancements of the available percentages of the cache memory and the whole chip.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A memory apparatus employing a bit-line division system, comprising:
a plurality blocks, each block including one or more memory cell arrays connected to divided bit lines;
a first decoder that generates a block select signal for selecting at least one of the blocks based on an inputted address signal;
a plurality of read/write portions corresponding to the respective blocks, each of the read/write portions executes read or write of the one or more memory cell arrays belonging to a respective block; and
a plurality of signal generation portions corresponding to the respective blocks, each of the signal generation portions generating an operation control signal for bringing the read/write portion that belongs to a specific block into an operating state when the specific block has been selected by the block select signal, and an operation control signal for bringing the read/write portion that belongs to the specific block into a non-operating state when the specific block is not selected by the block select signal.

2. A memory apparatus as claimed in claim 1, further comprising:
a plurality of second decoders corresponding to the respective blocks, each of the second decoders generates a word line select signal for selecting a word line of the one or more memory cell arrays that belong to the respective block.

3. A memory apparatus as claimed in claim 1, wherein the operation control signal includes at least one of a sense amplifier enable signal, a bit pre-charge signal, and a column select output node reset signal.

4. A memory apparatus as claimed in claim 3, further comprising:
a plurality of second decoders corresponding to the respective blocks, each of the second decoders generates a word line select signal for selecting a word line of the one or more memory cell arrays that belong to the respective block,
wherein each signal generation portion comprises a generation circuit that includes at least one of a circuit for generating the sense amplifier enable signal, a circuit for generating bit pre-charge signal, and a circuit for generating the column select output node reset signal.

5. A memory apparatus as claimed in claim 4, wherein each of the generation circuits and the second decoders further include a delay circuit.

6. A memory control method for controlling a memory apparatus that employs a bit-line division system and includes a plurality blocks, each block including one or more memory cell arrays connected to divided bit lines, a first decoder, a plurality of read/write portions corresponding to the respective blocks, and a plurality of signal generation portions corresponding to the respective blocks, the method comprising:
generating a block select signal for selecting a block based on an inputted address signal; and
allowing the signal generation portion that belongs to a block that is not selected by the block select signal to generate an operation control signal for bringing into a non-operating state the read/write portion that belongs to the non-selected block.

7. A memory control method as claimed in claim 6, wherein the signal generation portion that belongs to the block that is selected by the block select signal generates an operation control signal for bringing into an operating state the read/write portion that belongs to the selected block.

8. A memory control method as claimed in claim 6, further comprising generating a word line select signal that selects a word line of the memory cell array of the selected block,
wherein the operation control signal and the word line select signal are generated via circuits that have configurations identical to each other.

9. A memory control method as defined in claim 6, wherein the operation control signal includes at least one of a sense amplifier enable signal, a bit pre-charge signal, and a column select output node reset signal.

10. A memory control method as defined in claim 9, further comprising generating a word line select signal for selecting a word line of the memory cell array of the selected block,
wherein any of the sense amplifier enable signal, the bit pre-charge signal, the column select output node reset signal, and the word line select signal are generated via circuits that have configurations identical to each other.

11. A memory control method as claimed in claim 10, wherein the sense amplifier enable signal, the bit pre-charge signal, the column select output node reset signal, and the word line select signal are respectively endowed with adjusted delays.
